(19) United States
(12) Patent Application Publication
(10) Pub. No.: US 2002/0069083 A1
(43) Pub. Date: Jun. 6, 2002

(54) Method and apparatus for generating business activity-related model-based computer system output

(75) Inventors: Mark Harter, San Francisco, CA (US); Trevor Hughes, Saratoga, CA (US); Robert Nattenberg, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Exiprocity Solutions, Inc., San Francisco, CA

(21) Appl. No.: 10/007,196

(22) Filed: Dec. 5, 2001

Related U.S. Application Data
(60) Provisional application No. 60/251,985, filed on Dec. 5, 2000.

(51) Int. Cl. G06F 17/60

(52) U.S. Cl. 705/1

(57) ABSTRACT

A computer system and method that simplify the generation of business activity-related model-based output (e.g., spreadsheet output, output to software applications and output to visual displays). The method includes providing a computer system with a computer (e.g., a server computer), a user interface, a database (e.g., a relational database), an authoring editor module, an interview manager module, a rules generator module, a data manager module and an output generator module. Next, a set of model questions related to a business activity is created and stored in the database using the authoring editor module. An interactive interview is then presented to a user (via the user interface) using the interview manager module. The interactive interview includes a series of context-sensitive questions dynamically generated from the set of model questions by the interview manager module during the presentation of the interactive interview. During the interactive interview the data manager module can be used to import data from and export data to an external database or software application so the user may view and edit that data. Next, the rules generator module converts the stored answers into a set of rules that model the business activity and stores the set of rules in the database. A business activity-related model-based output from the computer system is subsequently generated based on the stored set of rules. Also provided is a computer system for generating business activity-related model-based output. The computer system includes a computer and a database. The computer includes a user interface, an authoring editor module, an interview manager module, a rules generator module, a data manager module and an output generator module configured to implement the aforementioned method.

### CROSS-REFERENCES TO RELATED APPLICATIONS

This application claims priority from co-pending U.S. Provisional Application No. 60/251,985, filed Dec. 5, 2000 and entitled “METHOD AND APPARATUS FOR AUTOMATICALLY GENERATING A BUSINESS PLAN,” which is hereby fully incorporated by reference for all purposes.

### BACKGROUND OF THE INVENTION

1. Field of the Invention

The present invention relates, in general, to computer systems and their associated methods and, in particular, to computer systems and methods for generating model-based output.

2. Description of the Related Art

Complex business activities (e.g., financial and business planning or modeling and product and vendor information gathering) are laborious undertakings, the completion of which is usually marked by the preparation of formatted business activity-related documents or other output that depicts various business models (e.g., revenue forecast models, budget forecast models and sales forecast models).

The successful completion of complex business activities currently requires significant time on the part of knowledgeable and trained personnel. Furthermore, conventional software-based computer systems and methods designed to assist in such complex business activities require significant staff, training and expense to implement and a broad range of specialized knowledge and skills on the part of users. For example, personnel from executive level management to financial staff and consultants are typically required to interact with existing desktop applications (EDA) (e.g., word processing and spreadsheet programs) and enterprise resource planning (ERP) software systems (e.g., Oracle Financials and SAP) in order to produce a financial model and associated formatted and model-based output.

Still needed in the field, therefore, is a computer system and associated method that simplify the generation of business activity-related model-based output. The computer system and method should reduce the number of steps and the complexity of tasks required to complete business activities, thereby increasing productivity and reducing expenses.

### BRIEF SUMMARY OF THE INVENTION

Methods and apparatus according to the present invention provide for the simplified generation of business activity-related model-based output (e.g., spreadsheet output, output to software applications and output to visual displays) from a computer system. The methods and apparatus, therefore, increase the productivity of business personnel involved in complex business related activities and reduce business expenses.

A method for generating business activity-related model-based output from a computer system in accordance with one exemplary embodiment of the present invention includes providing a computer system with a computer (e.g., a server computer), a user interface, a database (e.g., a relational database), an authoring editor module, an interview manager module, a rules generator module, a data manager module and at least one output generator module.

Next, a set of model questions related to a business activity is created and stored in the database using the authoring editor module. Subsequently, an interactive interview is presented to a user (via the user interface) using the interview manager module. The interactive interview includes a series of context-sensitive questions dynamically generated from the set of model questions by the interview manager module during the presentation of the interactive interview. The context-sensitive questions can also include answer data dynamically imported from an external database or software application by the data manager module. Next, the rules generator module converts the stored answers into a set of rules that model the business activity and stores the set of rules in the database. A business activity-related model-based output from the computer system is then generated based on the stored set of rules. Furthermore, if desired, any answer data which results from the interactive interview can be exported to an external database or software application using the data manager module.

In an alternative embodiment, the above process can be repeated, completely or partially as many times as required, by one or more people to complete, revise or regenerate a business activity-related model-based output and/or answer data for an external database or software application. For example, an interactive interview can be used repeatedly by many users (individually or collaboratively) to generate one or more sets of modified business activity-related model-based output. In addition, part or all of a previously completed interactive interview can be revisited and the original answers modified as many times as is necessary to make simple and/or fundamental changes to (i.e., modify) the business activity-related model-based output.

Also provided is a computer system for generating business activity-related model-based output. The computer system includes a computer and a database. The computer includes a user interface, an authoring editor module, and interview manager module, a rules generator module, a data manager module and at least one output generator modules.

The authoring editor module is configured for creating, and storing in the database, a set of model questions related to a business activity. The interview manager module is configured for presenting an interactive interview to a user via the user interface, and storing answers to the interactive interview provided by the user. The interactive interview presented by the interview manager module includes a series of context-sensitive questions dynamically generated from the set of model questions by the interview manager module during the presentation of the interactive interview.

The rules generator module is configured for converting the stored answers to the interactive interview into a set of rules that model the business activity, and storing the set of rules in the database. The data manager module is configured to dynamically import and export answer data between an external database and/or software application and the stored answers to the context-sensitive questions. Each of the at least one output generator modules are each configured for generating a different business activity-related model-based output (e.g., financial projections including income statement, balance sheet, statement of cash flow, budget, revenue projections and supporting schedules) from the computer system based on the stored set of rules.

Computer systems and methods according to one exemplary embodiment of the present invention provide for a user to generate and modify complex formatted and business activity-related model-based output (e.g., spreadsheet documents, word processing documents, presentation graphics, and structured data output for porting to desktop software applications, legacy computer systems, databases and enterprise software systems) by the simple answering of context-driven questions during an interactive interview, thus eliminating considerable time, expense and the need for specialized expertise on the part of the user. Furthermore, the apparatus and method also allow an interview author to quickly create an interactive interview (which can itself be considered an interactive interview software application that enables a user to generate or modify a business activity-related model-based output) without the need to expend the time and resources of specialized Information Technology (IT) staff. Methods and apparatus according to the present invention, therefore, provide for a significant cost savings and increase in productivity for personnel addressing complex business activities.

A better understanding of the features and advantages of the present invention will be obtained by reference to the following detailed description that sets forth illustrative embodiments, in which the principles of the invention are utilized, and the accompanying drawings.

### BRIEF DESCRIPTION OF THE DRAWINGS

FIG. 1 is a block diagram of a computer system according to an exemplary embodiment of the present invention; and

FIG. 2 is a flow diagram illustrating a sequence of steps in a process according to one exemplary embodiment of the present invention.

### DETAILED DESCRIPTION OF THE INVENTION

To be consistent throughout the present specification and for clear understanding of the present invention, the following definition is hereby provided for a term used therein:

The term “context-sensitive” refers to questions presented in an interactive interview process, wherein the answer(s) given to an interactive interview question(s) is used to determine which question(s) is subsequently presented to a user.

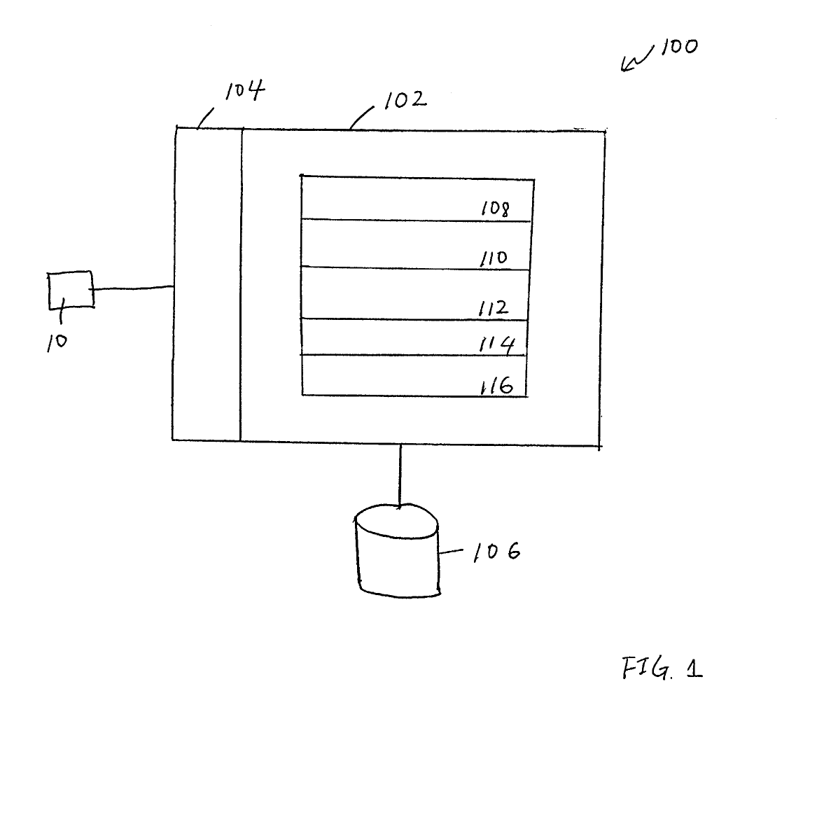

FIG. 1 is a block diagram of a computer system 100 for generating business activity-related model-based output according to an exemplary embodiment of the present invention. Computer system 100 includes server computer 102 with a user interface 104, which links computer system 100 to a user's Internet-enabled or web-enabled device 10.

Computer system 100 also includes a relational database 106 operatively coupled to server computer 102. Server computer 102 can be any suitable server computer known to one skilled in the art, such as those commercially available from Sun Microsystems and IBM. Relational database 106 can be any suitable relational database known to one skilled in the art including, but not limited to, an Oracle relational database.

Server computer 102 includes an authoring editor module 108, an interview manager module 110, a rules generator module 112, an output generator module 114, and a data manager module 116. Authoring editor module 108, interview manager module 110, rules generator module 112, output generator module 114, and data manager module 116 can be implemented, for example, using computer software resident on server computer 104. Computer programming languages and web page protocols known to those skilled in the art, such as C, C++, HTML (“HyperText Markup Language”), Java, DHTML and JavaScript, can be used for such implementation. It is recognized, however, that any suitable computer programming language or web page protocol can be used, including custom languages and protocols.

Authoring Editor module 108 is configured to facilitate the creation of the overall structure of an interactive interview in the form of a set of model questions and the format of answers to the set of model questions. Such an interactive interview is designed to gather information and data related to a complex business activity (e.g., creating a business plan, legal document or budget) from a user(s). In other words, the authoring editor module is used by an interview author and/or subject matter expert to create the content (i.e., model questions) that will be presented to a user(s) by the Interview Manager module.

The creation of the set of model questions can be accomplished, for example, by an interview author working, as needed, with a subject matter expert. An example of an interview author is a single staff member trained in use of the computer system, while a subject matter expert could be a company financial analyst. Alternatively, a single staff member with appropriate expertise and training in the use of the computer system could fill both these roles to create the set of model questions.

Authoring editor module 108 can be implemented as an authoring editor graphical user interface (GUI) tool (i.e., software application) that provides for the definition of various properties of a set of model questions (also referred to as an interactive interview) by an interview author. Each model question can be, for example, stored as a separate and distinct entity (e.g., a self-contained group of records) in relational database 106. The set of model questions (i.e., interactive interview) can include a series of distinct sections, each of which contains one or more “pages” which refer to a single display screen full of model questions. Each of these items can be stored, for example, as a separate and distinct entity (e.g., a self-contained group of records) in relational database 106.

Authoring editor module 108 can also be configured to provide an interview author with the ability to dynamically determine the flow of the model questions in the interactive interview when the interactive flow is presented to a user, by including controls between certain pages. Controls can cause the interview to branch (either conditionally or unconditionally) to another page, loop (conditionally or unconditionally) through a set of pages, or conditionally or unconditionally iterate multiple times through a self-contained set of pages, defined as a named procedure, passing arguments to that procedure and optionally returning a value. In this manner, the interview author can manage the set of model questions as a programming language. These controls, as with other items in the interactive interview, can be stored, for example, as a separate and distinct entity (e.g., a self-contained group of records) in relational database 106.

The named procedures defined in the above manner can be part of the interactive interview, and can also be saved to the relational database as part of one or more libraries of such named procedures. These libraries of named procedures can also be named, and can, if desired, be shared and distributed among various interview authors to allow many of the simple, common tasks of an interactive interview to be standardized and easily accessed. In addition and if desired, interview templates can be created, which represent the basic questions of a particular type of interactive interview (for example, a budgeting application). Such interview templates can also be shared and distributed among various interview authors, to provide anyone wishing to create an application of that particular type a framework for that interactive interview, which can then be modified to their exact requirements.

Such an authoring editor GUI tool can also be configured to provide an interview author with three views (i.e., visual displays) of the set of model questions: (a) a structure view showing a sequence of sections, pages, model questions, and controls; (b) a page view showing all the model questions on a specific page as they would be displayed to a user of the interview; and (c) a properties view showing details of the elements of a specific model section, page, model question, or control. Such views can be displayed, for example, on a display screen of a web-enabled device (not shown in the figures) connected to computer system 100.

In addition, such an authoring editor GUI tool can also be configured to provide a rules editor, i.e. a set of visual displays in which the various rules in an interactive interview can be displayed, and where a single rule formula may be edited as a mathematical equation and saved to the relational database 106.

Using the authoring editor GUI tool, an interview author creates a set of model questions designed to derive business-activity-related information from a user. These model questions are then be assembled as pages, which are then assembled as sections. The authoring editor can also build an overall structure for an interactive interview that provides for a logical and intuitive flow of context-sensitive questions to a user. Using the properties view feature, an interview author can also view and edit properties of a section, page, model question, or control.

The model questions created by an interview author can, for example, include default values (for numeric answers), a default paragraph (for text answers), or embedded database tokens which refer to a user's answers supplied earlier in an interactive interview. Such embedded database tokens will be replaced by corresponding database field values (or a conditional derivative of such database field values) before a model question is presented to a user as a context-sensitive question of an interactive interview. The embedded database tokens can refer to a question ID, which is queried in order to obtain the corresponding values.

Authoring editor module 108 can be configured to include a format editor, which can be used to specify the layout and format of the interactive interview as it is displayed to a user. Such a format editor can allow the interview author to specify the layout and format of an entire interactive interview, and/or some of the components (sections, pages, and model questions) of that interactive interview, by modifying their individual properties (see below). Where no layout and format information is specified for a particular item, it can inherit that information automatically from the higher level items (for example, a page would inherit its format from the section to which it belongs, or from the interview defaults if no associated section formatting information exists).

The authoring editor module can be configured, for example, to create a set of model questions wherein each section has one or more pages, each of which refer to a single (potentially scrollable) screen full of model questions. Sections, pages and model questions can be numbered logically in sequence. For example, Section 3, Page 5, model question 12 refers to a specific model question within that section and page.

Sections, pages and model questions can be objects with associated editable properties. Sections are groups of pages, typically associated with a common or related theme. Pages are groups of model questions used for viewing convenience and for ensuring the smooth flow between the context-sensitive model questions of an interactive interview being presented to a user. As described earlier, the properties relating to the objects within a given interactive interview are stored in database 106. Section properties which can be specified by an interview author or generated by the authoring module when creating a set of model questions include, for example:

Section ID number

Interview ID number

Section name

Purpose/summary description

Section format description

Submit warning flag (if section not completed)

Show page/question numbering flag

IDs of next & previous sections

ID of first page in section

Pre-Text (display at start of first page of section)

Post-text (display at end of last page of section)

Help text

Estimated time to complete section

Number of pages in this section

Number of questions in this section

List of requirements for this section

List of dependencies for this section

The term “requirements” in the list directly above refers to specific database field values that are required for an associated section to be accessed. If any of these requirements are not met, this section cannot be accessed from the interactive interview. The term “dependencies” in the list directly above refers to other sections that must be completed before this section is accessed by a user during an interactive interview. If these other sections are not completed first, this section cannot be completed by the user.

Page properties which can, for example, be specified by an interview author or generated by the authoring editor module when creating a set of pages include:

Page ID number

Section ID number

Interview ID number

Page name

Purpose/summary description

Page format description

Submit warning flag (if page not completed)

Show question numbering flag

IDs of next & previous pages

ID of first question on this page

Pre-Text (display at start of page)

Post-text (display at end of page)

Help text

Hints & Tips text

Style Guide text

Estimated time to complete page

Number of questions in this page

List of requirements for this page

List of dependencies for this page

As before, the term “requirements” in the list directly above refers to specific database field values that are required for a page to be accessed by a user during an interactive interview. If any of these requirements are not met, that page cannot be accessed in the interactive interview. The term “dependencies” in the list directly above refers to other pages which must be completed by a user before this page is accessed during an interactive interview. If these pages are not completed first, this page is not employed in the interactive interview.

Model question properties which can be specified by an interview author or generated by the authoring editor module when creating a set of model questions include, for example:

Question ID number

Page ID number

Section ID number

Interview ID number

Question name

Purpose/summary description

Question format description

Question text

Answer edit control type code

Answer data type

Answer style code

Required question flag

Key question flag

Answer values list (defaults)

Answer selected list (pre-selected values)

Answer max length

Answer visible size

IDs of next & previous questions

Pre-Text (display at start of question)

Post-text (display at end of question)

Rule variable

Rule expression

Submit post function

Submit post function argument

Database field mapping

Database field data type

Question style code

Help text

Example answer text

Hints & Tips text

Style Guide text

Boilerplate answer text

External question flag

External database access script

List of dependencies for a model question

List of requirements for a model question

As before, the term “requirements” in the list directly above refers to specific database field values that are required for a model question to be accessed by a user during an interactive interview. If any of these requirements are not met, that model question cannot be accessed in the interactive interview. The term “dependencies” in the list directly above refers to other model questions which must be completed by a user before this question is accessed during an interactive interview. If these model questions are not completed first, this model question is not employed in the interactive interview.

Control properties which can be specified by an interview author or generated by the authoring editor module when creating a set of model questions include, for example:

Control ID number

Section ID number

Interview ID number

Control name

Purpose/summary description

Question ID number (for conditional expressions)

Equality operator (for conditional expressions)

Value expression (for conditional expressions)

Control action type code (branch/iterate)

ID of page/control for branch/iterate

Other items which are part of the interactive interview can also be stored in the relational database 106 as a self-contained group of records. Each such item (including, for example, the interactive interview itself) can have its own set of properties specified by an interview author or generated by the authoring editor module, and which are essentially similar to those listed for sections, pages, model questions and controls, above.

There can, for example, be several different types of answer to a context-sensitive question derived from a model question. These types of answers can be specified by the interview author as one of the properties of the model question. Each answer type corresponds to a database field data type (or to a range of types), and a type of user input control, which the user interacts with on the page, in order to enter an answer during an interactive interview. The size of the control may vary considerably between, for example, a simple checkbox and a text edit box, so the exact page layout can determined by style codes specified by an interview author.

When certain answer types are displayed on a page (e.g., currency or percentage), the input control can be immediately preceded or followed by an appropriate character (in this case $ or %).

Authoring editor module 108 can also be configured to provide for the entry of predetermined model business rules into relational database 106, the use of which is described below.

A business rule consists of a named variable, and at least one formula associated with that variable. Each of these items can be stored as separate and distinct entities (e.g., a self-contained group of records) in relational database 106.

When an interview author uses authoring editor module 108 to create a set of model questions for an interactive interview, each model question can be assigned a rule expression (specified in the model question properties). Such a rule expression can be created and edited in the rules editor. A named variable can also be specified to which the rule will be assigned. When a question is answered by the user during the interview process, the rule expression is evaluated as described below, and a formula is created. This formula is then assigned to the named variable, and both are saved to relational database 106.

The interview author can create rule expressions which contain embedded coded references to various external values, which can only be determined at the time the rule expression is evaluated. When the rule expression is being evaluated and the resulting formula(e) generated, these coded references are replaced in the formula assigned to the specified variable by the external values to which they refer. Examples of these external values include:

Answer value (the value of an answer to a specific question)

Argument value (the current value of an argument passed in to a procedure)

Page name

Section name

Interview name

Model name

Page ID number

Section ID number

User name

Current date

Current time

The rule expressions specified by the interview author can also contain conditional elements which determine exactly how the formula is generated when the rule expression is evaluated. This might be in the form of one or more IF . . . THEN . . . ELSE . . . ENDIF clauses within the rule expression. When a formula is being generated from the rule expression, any such clauses will be evaluated, and the appropriate formula generated. These conditional elements can also contain embedded references to external values as described above. In such a case, the interview manager module can be configured to replace these embedded references with the appropriate external values prior to the conditional expression being evaluated.

Iinterview manager module 110 is configured to provide an interactive interface between a user(s) and the computer system (via user interface 104) and to control the process of selecting and filling-out (i.e., answering) context-sensitive questions of an interactive interview. For example, the interactive interface provided by the interview manager module can be a web-based portal, through which a user can work alone or collaboratively with other users to answer an interactive interview's context-sensitive questions.

The interview manager module presents a user with qualitative and quantitative context-sensitive questions about a company, business and/or market via an interactive interview and stores the user's answers in database 106. Once each page of context-sensitive questions has been answered by the user, the interview manager module automatically and dynamically generates the next page of context-sensitive questions of an interactive interview for a given user, based on the logical flow specified by the interview author. This automatic and dynamic generation can be readily accomplished when the authoring editor module has been employed to set the various properties of the sections, pages, questions, and controls in the interactive interview.

Typically, pages will follow each other in the order specified, however, whenever a control is located (by an interview author) after a page, the control specifies which page is displayed next. In addition, when a section or page has dependencies which are not satisfied by the user's answers to the previous questions, that section or page may be automatically omitted from the interactive interview by the interview manager module. Conversely, if a section or page has requirements which are not satisfied by the user's answers to the previous questions, the user may not be permitted to access such a section or page until those requirements have been satisfied.

Each control can determine the next page to be displayed by evaluating the conditional expression (if any) specified in the control properties (listed above), and if the value of the conditional expression is true, either branching or looping to the page specified in the control properties, or invoking a named procedure (i.e. a group of one or more pages and questions designed to perform a particular discrete function within the interview), passing any arguments to that procedure. If the conditional expression is false, the next page displayed is the following page in the same section of the interactive interview, or if none, the first page of the next section.

The conditional expression property of a control can include embedded coded references to external values, as described above. The interview manager can be configured to replace these embedded references with the appropriate external values prior to the conditional expression being evaluated.

The interview manager module can, for example, be configured as a generalized online interview software application, which uses a browser interface to guide a user through a series of context-sensitive questions in a structured manner.

The interview manager module is configured to essentially access the set of model questions created by the authoring editor module and display them (i.e., present them) to a user as a series of context-sensitive questions. The interview manager module can, for example, display the interactive interview in two separate windows (e.g., frames on a browser screen), namely a “Page Window,” which displays an individual page of context-sensitive questions on the right hand side of the screen, and a “Summary Window,” which displays a list of the sections, pages and context-sensitive question names in order as an outline view on the left side of the screen, together with an indication of the user's current position in the interactive interview.

The interview author may wish to allow a user to navigate though the interactive interview using the Summary Window to select the section, page, or context-sensitive question the user wishes to answer. In such a case, the interview manager module can be configured to update the Summary Window (as described below) and display the appropriate page in the Page Window. Selecting a section in this way would cause the first page in the section to be displayed, and selecting a page would display that page. Similarly, selecting a context-sensitive question would display the page which contains that question.

In such a Page Window, the interview manager module presents each page of context-sensitive questions to a user as a seamless and complete interactive interview process via a Web browser, according to the design parameters of the interactive interview specified by the interview author. The interview manager module can be configured to manage the ordering of sections, pages and context-sensitive questions, based upon the requirements and dependencies of the sections, pages and model questions. If certain sections or model questions are to be omitted from the interactive interview, the interview manager can be configured to detect this and automatically skip them, renumbering sections and model questions as required.

In a “Summary Window,” the interview manager module can, for example, display a text outline of all the sections, pages and context-sensitive question names in the interactive interview, together with a coded graphic (i.e., “traffic lights”) for each one indicating the completion status of that section selected from the following:

All non-optional questions in the section have been completed (Green);

The section is partially complete, but not all non-optional questions have been completed (Yellow);

The section has not yet been attempted (Red).

The interview manager module can be configured so that the interactive interview is reordered due to the answers supplied by the user, causing the display of both the Page Window and the Summary Window to be automatically updated to reflect the current state of the interactive interview. In the Page Window, the contents of the new page would be displayed. The Summary Window would automatically show the new order of the sections, pages and context-sensitive questions in the interactive interview, as well as any changes to the coded graphics (as above), and an updated indicator of the user's position in the interview.

The interactive interview pages can be assembled at the server computer as HTML pages for display in a user's browser. Prior to displaying each page, the database can be automatically queried to see if the user has already answered one or more context-sensitive questions derived from model questions on that page. If so, the existing answers can be first inserted into the appropriate answer fields as the page is generated.

Other aspects of the interview module manager are described in conjunction with methods according to the present invention.

Rules generator module 112 is configured to convert the stored answers to the interactive interview into a set of rules that model the business activity and to store the set of rules in the database, as described above. Rules generator module 112 can, for example, access the stored answers and convert the information contained in the stored answers into a set of rules (e.g., numerical equations) and then use the set of rules to generate a complex numerical or other model. For example, when the business related activity is finance related, the rules generator module can generate a set of rules (e.g., equations) that model a pro-forma financial statement. In this example, the user's stored answers would be converted into a set of business rules that accurately model project revenue, expenses, cash flow, inventory, etc. of the user's business. If desired, the rules can be combined with predefined business rules previously created by an interview author using a rules editor module in the authoring editor module. The step of converting the stored answers into a set of rules is entirely invisible to a user and requires no expertise on their part. In essence, the rules generator module accesses the stored answers and converts them into a set of rules (e.g., equations), which accurately model a user's assertions, assumptions and estimates as manifested in the stored answers.

The rules language used by the rules generator module is similar to simple algebraic equations. The language can include a series of variables (e.g., Sales, Expenses and Profit), each of which has a set of one or more associated rules which are used to calculate that variable, based on some combination of constant values, other variables, time-relative data, and financial, business, or mathematical functions. The rules can condense descriptions of certain assumptions, measurable metrics and intelligent estimates about a numerical model (based on the best information that can be supplied by the user) into a set of equations representing that model. For example, a simple financial rule might be:

Sales=$10,000 per month

Certain rules may inherently represent predefined business rules required for a particular business activity. For example, in a financial business activity, certain predefined business rules may be needed to represent common business and accounting knowledge or practices. These rules can be pre-created by an interview author and stored in a style sheet using the authoring editor module. For example:

Profit=Sales−Expenses

In practice, a rule may typically represent a single row (or possibly column) of a resulting spreadsheet, and so will be mapped to multiple cells when the spreadsheet is generated.

In a financial model, many of the rules will be time relative (i.e., the rules change the value of a variable based upon the time period), while other rules will be absolute (i.e., the rules will remain the same for all time periods).

For example, the questions and answers shown in the interactive interview described below can cause the following rules to be created:

1. Total Sales is equal to Direct Sales plus Retail Sales

2. Direct Sales for the first month is equal to $100,000

3. Direct Sales for each successive month is equal to $20,000

4. Retail Sales for the first month is equal to $50,000

5. Retail Sales for each successive month grows by 15%

Rule 1 is absolute (i.e., it doesn't change over time) and Rules 2-5 are specific to one or more time periods. Specifically, Rules 2 and 4 refer to the value of a variable in the first month of a monthly financial statement, and Rules 3 and 5 refer to the growth of that variable over time.

In practice, the rules can be stored in a more mathematically precise format, for example:

1. Total Sales=Direct Sales+Retail Sales

2. Direct Sales @Month[1]=$100,000

3. Direct Sales @Month[ ]=Direct Sales @Month [−1] +$20,000

4. Retail Sales @Month[1]=$50,000

5. Retail Sales @Month[ ]=Retail Sales [−1]+15%

The notation [number] in this example refers to the time period for which the rule applies. The notation [ ] is a special case which refers to the current time period for any given rule, and [−1] refers to the calculated value of that variable for the previous time period. In general, where there is a specific rule for a particular variable and time period (e.g., Rule 2), that rule takes precedence over rules which apply to multiple time periods (e.g., Rule 3). Absolute rules (e.g., Rule 1) take precedence overall relative rules (e.g. Rules 2 & 3).

Certain rules may require the use of one or more financial, business, or mathematical functions, typically similar to the common functions which are available in any spreadsheet product (e.g., sum, average and count). For example:

Quarter 1=SUM [1:3]

This rule indicates that Quarter 1 is a sum of periods (i.e., months) 1-3. In addition, users can define and name their own custom functions using rules.

The Rules Language can optionally allow more complex procedural calculations (e.g., conditional testing and repetitive calculations) to be built into individual rules. This enables the construction of extremely sophisticated financial or statistical modeling scenarios (e.g., allocations, goal seeking, etc.). A simple example:

Interest Expense=IF Average Balance<0, THEN Average Balance*Loan Rate, ELSE 0 ENDIF

Using the power and scope of the Rules Language gives a user the ability to create a sophisticated spreadsheet quickly, easily and in a repeatable fashion, with virtually no implementation errors.

The data manager module can be configured to dynamically import and export data between an external database or software application and the stored answers to the context-sensitive questions. Data can be imported from an external database or software application when an interactive interview is first started, and/or immediately before each page in that interactive interview is displayed to the user. Data can be exported to an external database or software application when an interactive interview is completed, and/or immediately after each page in that interview is completed by the user.

Because of the highly dynamic nature of the interactive interview process and the context-sensitive questions, it is necessary that the data manager also be able to access data in an external database or software application dynamically (as the questions themselves may be dynamically generated, any references to external data values by those questions must also be created dynamically). This can be achieved by creating queries and updates against the external database or software application dynamically while the user is executing the interactive interview, and utilizing such queries and updates to import and export the specific data items required for the context-sensitive questions in that interview.

The interview author can use the authoring editor module to create a number of database access scripts (written in, for example, XML or a similar language), which can be stored as one of the properties of any question which the author determines should be external (i.e. the answer for that question is stored in an external database or software application). Such an access script would describe in a dynamic way a set of logical properties of an external database or software application which would be needed to either query that external database to obtain the appropriate data values for the question, or to save those data values back to that external database. For example, such logical properties might include:

Logical server name

Logical database name

List of logical table names

List of logical field names

List of logical conditions

The interview author could choose the values for the various logical properties described above by selecting them from a list contained in a external mapping file (also written in XML or a similar language), which would be created in advance either by the author or by a product expert. This external mapping file would list the names of all the logical properties which might be required in the external database or software application, together with their equivalent physical names in the specific external database or software application to be used. Thus the data manager module could take a script from a given question, and using the master mapping file, convert that script into one or more specific query statements (for importing) or update statements (for exporting) in a query language (e.g. SQL) appropriate for that specific external database or software application.

The use of an external mapping file in this way facilitates both re-using the external mapping file for other interactive interviews which access the same external database or software application, and replacing the external mapping file with a different external mapping file to allow the interactive interview to be easily used with a completely different external database or software application.

Furthermore, the script for a given model question might contain conditional logic (IF . . . THEN . . . ELSE . . . ENDIF) statements, procedural statements (to perform iterative actions), and substitution parameters (as described above) which could be replaced with other values dynamically. This would facilitate the construction of complex and highly dynamic queries and updates for accessing an external database or software application, to match the context-sensitive questions in the interactive interview.

For performance efficiency, the data manager module can be configured to take the scripts for a group of model questions (for example, all the questions on a page in the interview), and combine them if possible (assuming they refer to the same database and table(s), in order to execute a single query or update statement against the external database instead of multiple queries or updates.

Once a query statement has been dynamically created and executed against the external database, the returned results (if they exist) would be imported and stored in the (internal) relational database 106 as answers (i.e., answer data) to the corresponding context-sensitive questions marked as external, and as described above, those answers would be inserted into the page containing those particular questions before it is displayed to the user. Then, once the user has answered those context-sensitive questions, the scripts from those questions marked as external (for which the user has also modified the answers) would be used to dynamically create an update statement and execute it against the external database to export the answers and replace the data values previously imported.

At least one output generator module is configured to generate output from the stored set of rules. Different output generator modules can be used to generate output for the various different target formats. One example of an output generator module 114 can generate XML based output capable of being delivered via web services applications to multiple output platforms, systems and software applications. Another output generator module 114 can generate any formatted (i.e., structured) document with tables, charts and diagrams. For example, the different output generator modules 114 can generate a business plan as a read-only file (e.g., a PDF file) or a fully editable word processor document (e.g., a Word or PDF format file).

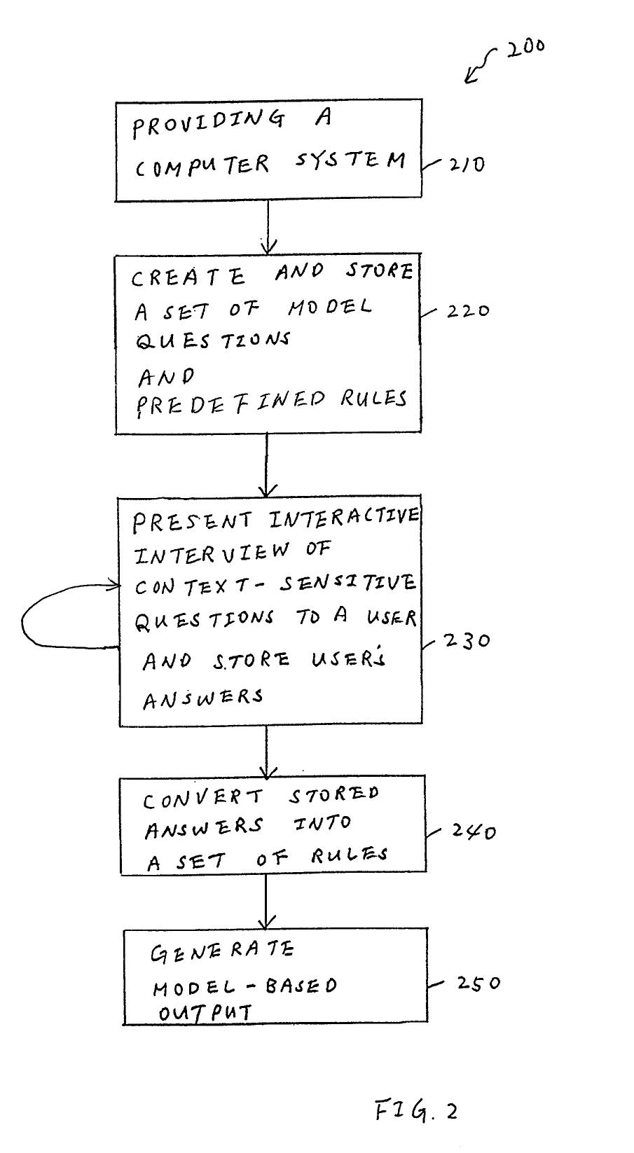

FIG. 2 is a flow diagram illustrating a sequence of steps in a method 200 that provides for generating business activity-related model-based output from a computer system, in accordance with one exemplary embodiment of the present invention. The method includes providing a computer system with a computer, a user interface, a database, an authoring editor module, an interview manager module, a data manager module, a rules generator module and an output generator module, as set forth in step 210. A set of model questions (and their associated sections, pages and controls) related to obtaining information from a user about a business related activity, and, if desired, predefined rules relating to that business activity are then created and stored in the database using the authoring editor module, as set forth in step 220.

Next, an interactive interview is presented to a user via the user interface, as set forth in step 230. The interactive interview that is presented to a user includes a series of context-sensitive questions dynamically generated from the set of model questions during the presentation of the interactive interview. During the interactive interview, answers provided by the user are stored in the database. The presentation of the interactive interview, storing of answers and dynamic generation of the series of context-sensitive questions are accomplished using the interview manager module. During the presentation of the interactive interview, a user's answers to context-sensitive questions are employed by the interview manager module, along with, for example, controls, requirements and/or dependencies specified by the interview author and/or answer data imported by the data manager module, to dynamically generate subsequent context-sensitive questions of the interactive interview. This dynamic aspect of the interactive interview presentation (which can be thought of as an iterative or looping procedure) is depicted by the circular arrow that both originates and ends at step 230 of FIG. 2.

If necessary and/or desired during the interactive interview, data values (i.e., answer data) are also imported and exported between an external database or software application and the answers stored in the database, to allow the user to view, edit and save data values from such an external database or software application, separately from any business activity-related model-based output produced. This process is accomplished using the data manager module.

The interview manager module can be configured such that the interactive interview is presented to a user in various predetermined manners. For example, to start an interactive interview, a user can either point their browser or follow a Web link to a URL (either on the Internet or an internal corporate intranet) previously provided to them by an application administrator, where the user will see an initial login screen. Once a user has logged in using, for example, a username and password, the user will see a screen with a hierarchical summary of all the interactive interview questions in a frame on the left hand side, and the first page of interactive interview questions on the right.

The user can simply answer the page of questions, and click on a “Next” button at the bottom of the page, which will bring up a next page of questions. The user can also go back a page using a “Previous” button. If desired, a user can click on any of the sections, pages or questions in the left-hand summary frame, and be taken directly to that item. The summary frame lists all the sections, pages, and questions, along with information about the status of each one, whether it has been completed, partially completed or not attempted yet. Some questions may also be grayed out, indicating that they are not relevant given the context of the interactive interview. It should be noted that the user's progress through the questions in the interview is always context-driven (e.g., the answers they give will determine which questions they are subsequently asked).

During the presentation step, the interview manager module presents an interactive interview to a user, in order to extract the necessary information about the business related activity. For example, for a business planning activity, the interview manager module would present many questions to determine the specific functional details of the business. The answers which the user supplies are stored as a series of records in the database.

A simple example of a portion of an interactive interview is given below:

Revenue Sources Section

This section asks you some questions about where your company's revenue comes from:

1. Does your company sell its product directly to the public? ●Yes ∘No

2. Does your company sell its products through distributors? ∘Yes ●No

3. Does your company sell its products through retailers? ●Yes ∘No

Revenue Detail Section

This section asks you some specific questions about each of your company's revenue sources:

1. Which of the following methods do you wish to use to estimate the growth in revenue from direct sales to the public?

Grows by a fixed amount per month

Grows by a fixed percentage per month

Grows as a function of another metric (e.g. Advertising)

Grows as a function of the number of employees in a role (e.g. Salespeople)

Enter formula directly (experts only)

2. Which method do you wish to use to estimate the growth in revenue from sales through distributors?

Grows by a fixed amount per month

Grows by a fixed percentage per month

Grows as a function of another metric (e.g. Advertising)

Grows as a function of the number of retail stores

Enter formula directly (experts only)

Revenue Estimates Section

This section asks you to estimate your company's revenue and revenue growth:

1. What is the estimated first month's revenue from direct sales? $100,000

2. What is the monthly dollar growth in revenue from direct sales? $20,000

3. What is the estimated first month's revenue from distributors? $50,000

4. What is the monthly percentage growth in revenue from distributors? 15%

Next, the stored answers are converted, using the rules generator module, into a set of rules that model the business activity, and are then stored in the database, as set forth in step 240 of FIG. 2. Aspects of such a rule generation step were described above with respect to the rule generator module. A business activity-related model-based output (e.g., a spreadsheet, presentation or output to a software application or display screen) is subsequently generated (using an output generator module) from the computer system based on the stored set of rules, as set forth in step 250.

It should be understood that various alternatives to the embodiments of the invention described herein may be employed in practicing the invention. It is intended that the following claims define the scope of the invention and that structures and methods within the scope of these claims and their equivalents be covered thereby.

What is claimed is:

1. A method for generating business activity-related model-based output from a computer system, the method comprising:
providing a computer system with a computer, a user interface, a database, an authoring editor module, an interview manager module, a rules generator module, a data manager module and at least one output generator module;
creating, and storing in the database, a set of model questions related to a business activity using the authoring editor module;
presenting, using the interview manager module, an interactive interview to a user via the user interface, and storing answers to the interactive interview provided by the user and answer data dynamically imported using the data manager module, wherein the interactive interview includes a series of context-sensitive questions dynamically generated from the set of model questions by the interview manager module during the presentation of the interactive interview;
converting, using the rules generator module, the stored answers to the interactive interview into a set of rules that model the business activity and storing the set of rules in the database; and
generating a business activity-related model-based output from the computer system based on the stored set of rules.

2. The method of claim 1, further comprising during the providing step, providing a server computer and a relational database.

3. The method of claim 1, further comprising during the presenting step, presenting an interactive web-based interview.

4. The method of claim 1, further comprising during the creating step, creating a set of model questions via a graphical user interface (GUI) managed by the authoring editor module.

5. The method of claim 1, further comprising during the generating step, generating the business activity-related model-based output as an XML-based output.

6. The method of claim 1, further comprising during the providing step, providing a computer system that additionally includes a format module configured to format a business activity-related model-based output and wherein the generating step generates a formatted and model-based business activity-related output.

7. The method of claim 1, further comprising during the creating step, creating controls that determine a flow of context-sensitive questions during the interactive interview and storing the controls in the database.

8. The method of claim 1, further comprising during the creating step, creating predefined rules related to the business activity and, during the converting step, converting the stored answers and the predefined rules into a set of rules that model the business activity.

9. The method of claim 1, further comprising during the presenting step, presenting an interactive interview to a plurality of users in a collaborative manner and storing answers collaboratively provided by the plurality of users.

10. The method of claim 1, further comprising during the presenting step, presenting an interactive interview wherein the interactive interview includes a series of context-sensitive questions dynamically generated from the set of model questions and the answer data by the interview manager module during the presentation of the interactive interview.

11. A computer system for generating business activity-related model-based output, the computer system comprising:
a computer; and
a database,
wherein the computer includes:
a user interface;
an authoring editor module configured for creating, and storing in the database, a set of model questions related to a business activity;
an interview manager module configured for presenting an interactive interview to a user via the user interface, and storing answers to the interview provided by the user, wherein the interactive interview includes a series of context-sensitive questions dynamically generated from the set of model questions by the interview manager module during the presentation of the interactive interview;
a data manager module configured to dynamically import answer data during the presentation of the interactive interview;
a rules generator module configured for converting, using the rules generator module, the stored answers to the interactive interview into a set of rules that model the business activity and storing the set of rules in the database; and
at least one output generator module configured for generating a business activity-related model-based output from the computer system based on the stored set of rules.

12. The computer system of claim 11, wherein the authoring editor module, interview manager module, data manager module, rules generator module and output generator module include software programs resident on the computer.

13. The computer system of claim 11, wherein the computer is a server computer, the user interface is configured for linking, via the Internet, a user's Internet-enabled device to the computer system, and the interface module is configured for presenting the interactive interview to the user via the user's Internet-enabled device.

14. The computer system of claim 11, wherein the interview manager module is configured to present an interactive web-based interview.

15. The computer system of claim 11, wherein there are a plurality of output generator modules with each of the output generator modules configured to generating a different business activity-related model-based output.

16. The computer system of claim 11, wherein the interview manager module is configured to present a plurality of users with an interactive interview in a manner which provides for storing answers collaboratively provided by the plurality of users.

17. The computer system of claim 11, wherein the data manager module is also configured to export answer data and answers provided by a user during the interactive interview.
